(19) United States
(12) Patent Application Publication
(10) Pub. No.: US 2015/0044659 A1
(43) Pub. Date: Feb. 12, 2015

(54) CLUSTERING SHORT ANSWERS TO QUESTIONS

(71) Applicant: Microsoft Corporation, Redmond, WA (US)

(72) Inventors: Sumit Basu, Seattle, WA (US); Lucretia Vanderwende, Sammamish, WA (US); Charles Jacobs, Seattle, WA (US)

(73) Assignee: Microsoft Corporation, Redmond, WA (US)

(21) Appl. No.: 13/961,883

(22) Filed: Aug. 7, 2013

(51) Int. Cl. G09B 7/04

(52) U.S. Cl. CPC G09B 7/04
USPC 434/350

(57) ABSTRACT

A method, computing system, and one or more computer-readable storage media for clustering short answers to questions are provided herein. The method includes receiving, at a computing device, a number of short answers to a question from a number of remote computing devices. The method also includes automatically grouping the short answers into a number of clusters based on features corresponding to the short answers using a specified clustering technique.

### BACKGROUND

Increasing access to quality education is a global issue, and one of the most exciting developments in recent years has been the introduction of massively online open courses (MOOCs). MOOCs allow hundreds of thousands of students to take courses online. Due to the large number of students in each MOOC, assessment in the form of quizzes and exams presents some significant challenges. One straightforward solution is to use multiple choice questions; however, open response (short answer) questions provide far greater educational benefit. However, grading short answers to questions is often cost prohibitive, particularly for MOOCs including large numbers of students.

Several current techniques include automatically grading short answers as correct or incorrect, or with numerical scores. However, in practice, such techniques have several drawbacks. First, such techniques are not 100% accurate, and there is no assistance from these systems to deal with those answers that are not graded correctly. Second, such techniques only allow for the assignment of an overall score. However, teachers often prefer to give specific feedback to students. Third, such techniques do not allow the teacher to discover consistent patterns of misunderstanding among students. Therefore, improved techniques for grading short answers to questions are desirable.

### SUMMARY

The following presents a simplified summary of the subject innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

An embodiment provides a method for clustering short answers to questions. The method includes receiving, at a computing device, a number of short answers to a question from a number of remote computing devices. The method also includes automatically grouping the short answers into a number of clusters based on features corresponding to the short answers using a specified clustering technique.

Another embodiment provides a computing system for clustering short answers to questions. The computing system includes a processor that is configured to execute stored instructions and a network that is configured to communicably couple the computing system to a number of remote computing systems. The computing system also includes an interface that is configured to allow a user of the computing system to provide feedback and system memory. The system memory includes code configured to receive a set of short answers for an assessment from each of the number of remote computing devices. Each set of short answers includes a short answer to each of a number of questions within the assessment. The system memory also includes code configured to automatically group the short answers to each of the questions within the assessment into a number of clusters based on features corresponding to the short answers using a specified clustering technique. The system memory further includes code configured to label each of the clusters corresponding to each of the questions with a label or a score based on the feedback from the user or model short answers to the questions obtained from an answer key, or both.

In addition, another embodiment provides one or more computer-readable storage media for storing computer-readable instructions. The computer-readable instructions provide a system for clustering short answers to questions when executed by one or more processing devices. The computer-readable instructions include code configured to receive a number of short answers to a question from a number of remote computing devices and automatically group the short answers into a number of clusters based on features corresponding to the short answers using a specified clustering technique.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of a computing environment that may be used to implement a system and method for clustering short answers to questions;

FIG. 2 is a process flow diagram of a method for clustering short answers to questions;

FIG. 3 is a process flow diagram of a method for grading an assessment by clustering short answers to questions;

FIG. 4 is a schematic showing a method for labeling particular clusters of short answers as correct or incorrect;

FIG. 5 is a graph showing the performance of the similarity metric described herein;

FIG. 6 is a graph showing the performance of the similarity metric described herein when each feature is trained individually;

FIG. 7 is a graph showing the number of user actions that are left to correctly grade a particular question according to several different clustering techniques; and

FIG. 8 is a graph showing the number of user actions that are left to correctly grade another question according to several different clustering techniques.

### DETAILED DESCRIPTION

Decades of educational research have demonstrated the importance of assessment in learning. Testing contributes in multiple ways to the learning process. Testing is formative when used to guide the learning process, and summative when used to evaluate the student. In addition, testing has been shown to play a significant role in the learning process by assisting in retention, and answer construction for open response, or short answer, questions has been shown to play a significant role in consolidating learning.

Although multiple choice questions (MCQs) are currently the most popular method of assessment for large-scale online courses or exams due to the relative ease of grading, there are drawbacks to the use of MCQs. Specifically, while the summative value of MCQs may be obvious, the formative value of MCQs is questionable. Additionally, answering MCQs involves simply recognizing the correct answer. This is known to be an easier task than constructing the answer in short answer form.

Short answers to questions are challenging to grade. However, testing with short answer questions is both summative and formative. Current techniques for grading short answers rely on careful authoring of the expected answer(s). For example, one technique uses a paraphrase recognizer known as C-rater to identify rephrasings of an answer key as correct answers. To recognize the rephrasings, C-rater uses sophisticated linguistic processing and automatic spelling correction. However, this technique may only be worthwhile if the teacher uses the same questions for an extended period of time, since the creation of the model answers to the questions may represent a considerable time investment. Similarly, another technique uses an authoring tool that enables a question author with no knowledge of natural language processing (NLP) to use the software. However, according to this technique, all of the linguistically similar forms of the correct answer are to be encoded prior to grading, and unanticipated student answers cannot be graded appropriately. Another technique involves formulating short answer grading as a similarity task in which a score is assigned based on the similarity of the teacher's answers and the individual students' answers. However, this technique is also not 100% accurate.

Accordingly, embodiments described herein describe improved techniques for machine-assisted grouping of short answers to questions into clusters. In various embodiments, the clustering of shorts answers allows the short answers to be easily graded. According to various embodiments described herein, a general similarity metric may be trained to allow similar short answers to be clustered together. The similarity metric may then be used to group specific short answers into clusters and subclusters. The resulting clusters and subclusters may allow teachers to grade multiple short answers with a single action, provide rich feedback (comments) to groups of similar short answers, and discover modalities of misunderstanding among students. In addition, embodiments described herein provide for the automatic grading of short answers to questions when an answer key is available, further reducing the teacher effort.

While current techniques attempt to grade short answers to questions completely automatically, embodiments described herein leverage the abilities of both the human and the machine to grade short answers to questions according to the “divide and conquer” approach. Specifically, instead of classifying individual short answers as being correct or incorrect, embodiments described herein automatically form clusters and subclusters of similar short answers from a large set of short answers to the same question. This is possible because short answers to a particular question typically cluster into groups around different modes of understanding or misunderstanding. In various embodiments, the clusters and subclusters are formed automatically without any model of the question or its answers. Once the clusters and subclusters have been formed, teachers may apply their expertise to mark the individual clusters and/or subclusters as correct or incorrect. For example, a teacher may mark entire clusters and/or subclusters as correct or incorrect, and give rich feedback (comments) to a whole group at once. This technique may increase the teacher's self-consistency and provide the teacher with an overview of the students' levels of understanding and misunderstanding. Furthermore, if an answer key is available, the answer key may be used to mark at least a portion of the clusters as correct or incorrect, or mark at least a portion of the clusters with numerical scores indicating relative correctness or incorrectness.

In practice, implementation of the “divide and conquer” approach of clustering and subclustering short answers is challenging, since students express similar short answers in many different ways. Conventional clustering techniques, such as latent Dirichlet allocation (LDA), attempt to explain similarities between short answers in terms of topics that are distributions over words. However, such conventional clustering techniques are limited by their reliance on word-based representations of text. Therefore, according to various embodiments described herein, short answers are clustered based on a learned model of distance, with an array of features that expands over time. Specifically, a distance function may be modeled by training a classifier that predicts whether two short answers are to be grouped together. According to the distance function, two short answers that are simply paraphrases of each other are determined to be close together, i.e., similar, and are grouped into the same cluster and/or subcluster. Because the distance function models the distance between short answers as opposed to the short answers themselves, “between-item” features can be used to measure semantic or spelling differences. Therefore, the classifier may be provided with features that account for misspellings, changes in verb tense, and other variations in the short answers.

To evaluate the efficiency of the cluster-based approach described herein, it may be desirable to determine the grading progress a teacher can achieve with a given amount of effort. Such a determination may be made using “grading on a budget” criteria, which relate to the grading progress achieved for a particular number of teacher actions. In addition, such a determination may be made based on “effort left for perfection” criteria, which relate to the number of additional teacher actions left to grade all short answers correctly. Evaluating the cluster-based approach described herein according to these criteria reveals that the approach described herein leads to substantially better results than techniques that rely exclusively on LDA or the individual classification of items.

It is to be understood that, while embodiments are described herein with respect to the grading of short answers to questions, the techniques described herein may also be used to cluster short answers for a variety of other purposes. In some embodiments, the clustering of short answers may be used to simply compare different types of responses to questions, especially when correct responses to the questions have not been defined. For example, short answers to a particular online forum question or survey may be clustered to determine similarities and differences between the short answers. The similarities and differences between the shorts answers may provide some indication of the public's view of the correct answer to the online forum question, regardless of whether a correct answer to the online forum question can actually be defined.

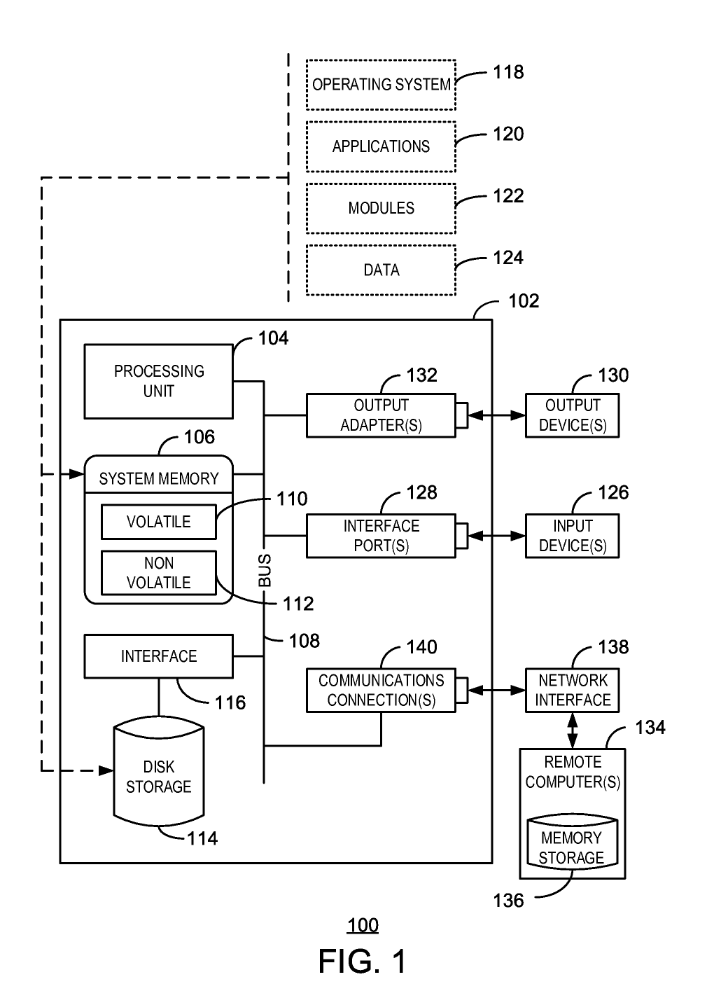

As a preliminary matter, some of the figures describe concepts in the context of one or more structural components, variously referred to as functionality, modules, features, elements, or the like. The various components shown in the figures can be implemented in any manner, such as via software, hardware (e.g., discrete logic components), firmware, or any combinations thereof. In some embodiments, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like.

The term “logic” encompasses any functionality for performing a task. For instance, each operation illustrated in the flowcharts corresponds to logic for performing that operation. An operation can be performed using, for instance, software, hardware, firmware, or the like.

As used herein, the terms “component,” “system,” “client,” “server,” and the like are intended to refer to a computer-related entity, either hardware, software (e.g., in execution), or firmware, or any combination thereof. For example, a component can be a process running on a processor, an object, an executable, a program, a function, a library, a subroutine, a computer, or a combination of software and hardware.

By way of illustration, both an application running on a server and the server can be a component. One or more components can reside within a process, and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable storage device or media.

Computer-readable storage media can include but are not limited to magnetic storage devices (e.g., hard disk, floppy disk, and magnetic strips, among others), optical disks (e.g., compact disk (CD) and digital versatile disk (DVD), among others), smart cards, and flash memory devices (e.g., card, stick, and key drive, among others). In contrast, computer-readable media (i.e., not storage media) generally may additionally include communication media such as transmission media for wireless signals and the like.

Computing Environment for Clustering Short Answers to Questions

In order to provide context for implementing various aspects of the claimed subject matter, FIG. 1 and the following discussion are intended to provide a brief, general description of a computing environment in which the various aspects of the subject innovation may be implemented. For example, a method and system for clustering short answers to questions can be implemented in such a computing environment. While the claimed subject matter has been described above in the general context of computer-executable instructions of a computer program that runs on a local computer or remote computer, those of skill in the art will recognize that the subject innovation also may be implemented in combination with other program modules. Generally, program modules include routines, programs, components, data structures, or the like that perform particular tasks or implement particular abstract data types.

Moreover, those of skill in the art will appreciate that the subject innovation may be practiced with other computer system configurations. For example, the subject innovation may be practiced with single-processor or multi-processor computer systems, minicomputers, mainframe computers, personal computers, hand-held computing systems, microprocessor-based or programmable consumer electronics, or the like, each of which may operatively communicate with one or more associated devices. The illustrated aspects of the claimed subject matter may also be practiced in distributed computing environments wherein certain tasks are performed by remote processing devices that are linked through a communications network. However, some, if not all, aspects of the subject innovation may be practiced on stand-alone computers. In a distributed computing environment, program modules may be located in local or remote memory storage devices.

FIG. 1 is a block diagram of a computing environment 100 that may be used to implement a system and method for clustering short answers to questions. The computing environment 100 includes a computer 102. The computer 102 includes a processing unit 104, a system memory 106, and a system bus 108. The system bus 108 couples system components including, but not limited to, the system memory 106 to the processing unit 104. The processing unit 104 can be any of various available processors. Dual microprocessors and other multiprocessor architectures also can be employed as the processing unit 104.

The system bus 108 can be any of several types of bus structures, including the memory bus or memory controller, a peripheral bus or external bus, or a local bus using any variety of available bus architectures known to those of ordinary skill in the art. The system memory 106 is computer-readable storage media that includes volatile memory 110 and non-volatile memory 112. The basic input/output system (BIOS), containing the basic routines to transfer information between elements within the computer 102, such as during start-up, is stored in non-volatile memory 112. By way of illustration, and not limitation, non-volatile memory 112 can include read-only memory (ROM), programmable ROM (PROM), electrically-programmable ROM (EPROM), electrically-erasable programmable ROM (EEPROM), or flash memory.

Volatile memory 110 includes random access memory (RAM), which acts as external cache memory. By way of illustration and not limitation, RAM is available in many forms, such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 102 also includes other computer-readable storage media, such as removable/non-removable, volatile/non-volatile computer storage media. FIG. 1 shows, for example, a disk storage 114. Disk storage 114 may include, but is not limited to, a magnetic disk drive, floppy disk drive, tape drive, Jaz drive, Zip drive, LS-100 drive, flash memory card, or memory stick.

In addition, disk storage 114 can include storage media separately or in combination with other storage media including, but not limited to, an optical disk drive such as a compact disk ROM device (CD-ROM), CD recordable drive (CD-R Drive), CD rewritable drive (CD-RW Drive), or a digital versatile disk ROM drive (DVD-ROM). To facilitate connection of the disk storage 114 to the system bus 108, a removable or non-removable interface is typically used, such as interface 116.

It is to be appreciated that FIG. 1 describes software that acts as an intermediary between users and the basic computer resources described in the computing environment 100. Such software includes an operating system 118. The operating system 118, which can be stored on disk storage 114, acts to control and allocate resources of the computer 102.

System applications 120 take advantage of the management of resources by the operating system 118 through program modules 122 and program data 124 stored either in system memory 106 or on disk storage 114. It is to be appreciated that the claimed subject matter can be implemented with various operating systems or combinations of operating systems.

A user enters commands or information into the computer 102 through input devices 126. Input devices 126 can include, but are not limited to, a pointing device (such as a mouse, trackball, stylus, or the like), a keyboard, a microphone, a gesture or touch input device, a voice input device, a joystick, a satellite dish, a scanner, a TV tuner card, a digital camera, a digital video camera, a web camera, or the like. The input devices 126 connect to the processing unit 104 through the system bus 108 via interface port(s) 128. Interface port(s) 128 can include, for example, a serial port, a parallel port, a game port, and a universal serial bus (USB). Output device(s) 130 may also use the same types of ports as input device(s) 126. Thus, for example, a USB port may be used to provide input to the computer 102 and to output information from the computer 102 to an output device 130.

An output adapter 132 is provided to illustrate that there are some output devices 130 like monitors, speakers, and printers, among other output devices 130, which are accessible via the output adapters 132. The output adapters 132 include, by way of illustration and not limitation, video and sound cards that provide a means of connection between the output device 130 and the system bus 108. It can be noted that other devices and/or systems of devices provide both input and output capabilities, such as remote computer(s) 134.

The computer 102 may be included within a networking environment, and may include logical connections to one or more remote computers, such as remote computer(s) 134. According to various embodiments described herein, the computer 102 may be operated by a teacher, while the remote computer(s) 134 may be operated by students. In such embodiments, the computer 102 may receive short answers to particular questions from the remote computer(s) 134 and may perform the techniques described herein for clustering the short answers according to particular clustering techniques and, optionally, determining labels or scores for particular clusters of short answers.

The remote computer(s) 134 may be personal computers, mobile devices, or the like, and may typically include many or all of the elements described relative to the computer 102. For purposes of brevity, the remote computer(s) 134 are illustrated with a memory storage device 136. The remote computer(s) 134 are logically connected to the computer 102 through a network interface 138, and physically connected to the computer 102 via a communication connection 140.

Network interface 138 encompasses wired and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 140 refers to the hardware and/or software employed to connect the network interface 138 to the system bus 108. While communication connection 140 is shown for illustrative clarity inside the computer 102, it can also be external to the computer 102. The hardware and/or software for connection to the network interface 138 may include, for example, internal and external technologies such as mobile phone switches, modems including regular telephone grade modems, cable modems and DSL modems, ISDN adapters, and Ethernet cards.

Methods for Clustering Short Answers to Questions

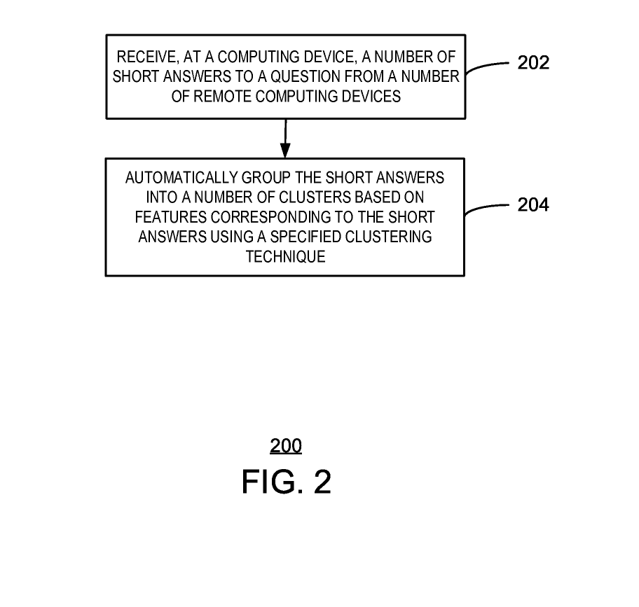

FIG. 2 is a process flow diagram of a method 200 for clustering short answers to questions. The method 200 may be implemented by any suitable type of computing device, such as the computer 102 described with respect to the computing environment 100 of FIG. 1. The method begins at block 202, at which a number of short answers to a question are received from a number of remote computing devices. In various embodiments, the computing device implementing the method 200 may be operated by a teacher, and the remote computing devices may be operated by the teacher's students.

At block 204, the short answers are automatically grouped into a number of clusters based on features corresponding to the short answers using a specified clustering technique. In some embodiments, the specified clustering technique includes using a trained similarity metric. In other embodiments, the specified clustering technique includes using an LDA algorithm. Moreover, any other suitable clustering technique may also be used according to embodiments described herein.

In various embodiments, any of the clusters may be marked with a label (i.e., a specific comment or a categorical label, such as a correct label or an incorrect label) or with a score (i.e., a numerical indication of relative correctness or incorrectness) based on feedback from a user of the computing device. In addition, if an answer key is available, the answer key may be used to label or score at least a portion of the clusters. For example, if the specified clustering technique includes using the trained similarity metric, the similarity between the model correct and/or incorrect short answers included in the answer key and the short answers within a cluster may be determined, and the cluster may be labeled or scored based on the determined similarity. Alternatively, if the specified clustering technique includes using the LDA algorithm, the short answers to the question and a model short answer to the question obtained from the answer key may be automatically grouped into clusters based on features corresponding to the short answers and the model short answers using the LDA algorithm. The cluster that includes each model short answer to the question may then be identified, and that cluster may be labeled or scored based on whether the model short answer represents a correct answer or an incorrect answer.

Furthermore, the clusters may be further subdivided into any number of subclusters. The user may then be allowed to relabel or rescore any of the clusters and/or subclusters. In addition, the user may be allowed to individually relabel or rescore any of the short answers within the subclusters.

In various embodiments, the computing device displays a report to the user. The report may include information relating to the labels or scores of the clusters, as well an overview of the distribution of the short answers based on the clusters. In addition, the report may include specific information and/or statistics relating to particular modes of understanding or misunderstanding corresponding to the short answers within each cluster. Furthermore, the computing device may receive feedback corresponding to a particular cluster from the user of the computing device, and may send such feedback to the remote computing devices from which the short answers within the particular cluster were received. The feedback may include labels (i.e., specific comments or categorical labels, such as correct or incorrect labels) or numerical scores corresponding to particular clusters or subclusters, for example. In this manner, the user (i.e., the teacher) may quickly and efficiently provide rich feedback (comments) to entire groups of students that share common modes of understanding or misunderstanding.

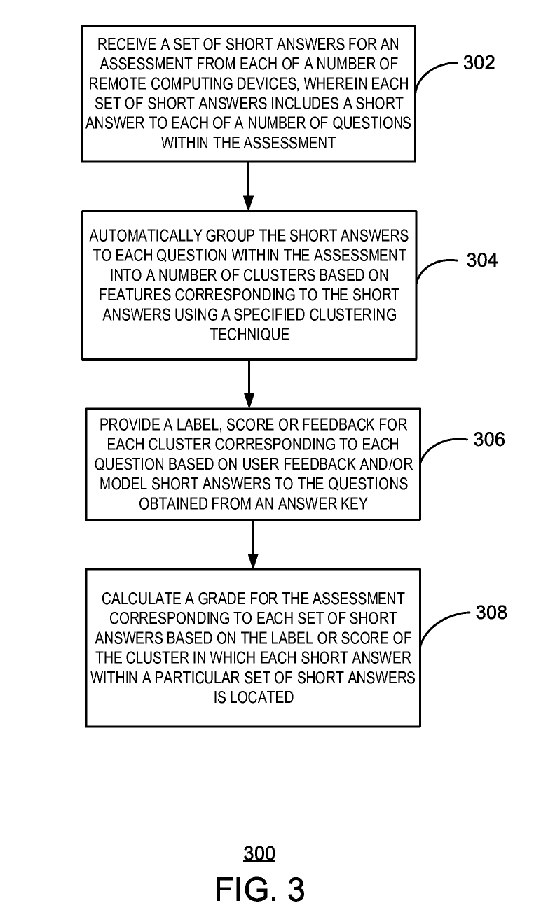

The process flow diagram of FIG. 2 is not intended to indicate that the blocks of the method 200 are to be executed in any particular order, or that all of the blocks are to be included in every case. Further, any number of additional blocks not shown in FIG. 2 may be included within the method 200, depending on the details of the specific implementation. For example, in various embodiments, the clusters may be used to grade a student assessment, or test, including one or more short answer questions, as discussed further with respect to FIG. 3.

FIG. 3 is a process flow diagram of a method 300 for grading an assessment by clustering short answers to questions. The method 300 may be implemented by any suitable type of computing device, such as the computer 102 described with respect to the computing environment 100 of FIG. 1. The method begins at block 302, at which a set of short answers for an assessment are received from each of a number of remote computing devices. Each set of short answers includes a short answer to each of a number of questions within the assessment. In various embodiments, the computing device implementing the method 200 may be operated by a teacher, and the remote computing devices may be operated by the teacher's students.

At block 304, the short answers to each of the questions within the assessment are automatically grouped into a number of clusters based on features corresponding to the short answers using a specified clustering technique. At block 306, each cluster corresponding to each question is labeled with a label (i.e., a specific comment or a categorical label, such as a correct label or an incorrect label) or a score (i.e., with a numerical indication of relative correctness or incorrectness) based on the feedback from the user and/or model short answers to the questions obtained from an answer key. Blocks 304 and 306 may be performed as described with respect to the method 200 of FIG. 2. However, the clusters and subclusters may be formed for short answers relating to each of a number of different questions, rather than simply for short answers relating to a single question.

At block 308, a grade for each student's assessment is calculated based on the label or score of the cluster in which each short answer within a particular set of short answers is located. In other words, a set of short answers relating to a particular student's assessment may be identified across all the answer sets, and the labels or scores of those short answers may be used to determine whether the student answered each question within the assessment correctly or incorrectly. In this manner, embodiments described herein allow a large number of student assessments to be quickly and efficiently graded with very little user/teacher input. This may be particularly useful for grading student assessments for massively online open courses (MOOCs), for example.

The process flow diagram of FIG. 3 is not intended to indicate that the blocks of the method 300 are to be executed in any particular order, or that all of the blocks are to be included in every case. Further, any number of additional blocks not shown in FIG. 3 may be included within the method 300, depending on the details of the specific implementation. For example, in various embodiments, already-labeled (or already-scored) clusters or individual short answers within the already-labeled (or already-scored) clusters are used to determine the labels or scores for any unlabeled, unscored clusters or individual short answers. In other words, in such embodiments, the already-labeled (or already-scored) clusters or individual short answers effectively become an answer key that is created from student-generated responses rather than teacher input. Such an answer key may contain both known correct and incorrect answers, so that these can be used to label future answers that are similar correct and incorrect answers, respectively. The student-generated answer key may be continuously updated as more clusters and individual short answers are labeled or scored, and may be used to label or score short answers that are received from remote computing devices at subsequent points in time. For example, if a teacher uses the same assessment multiple times, the student-generated answer key may be used to grade short answers to the assessment during subsequent school terms.

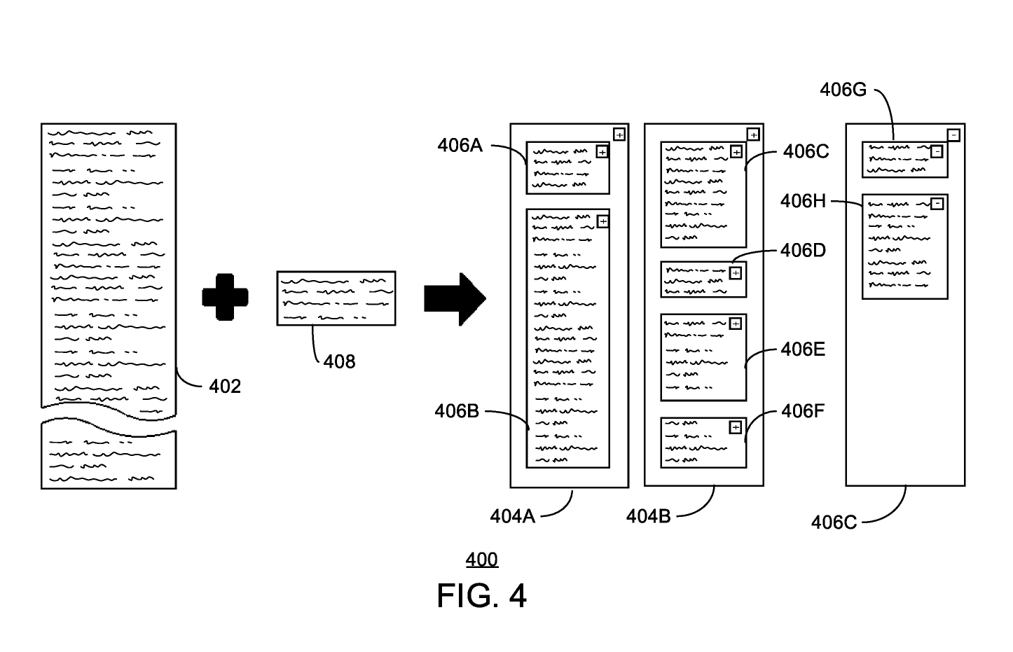

FIG. 4 is a schematic showing a method 400 for labeling particular clusters of short answers as correct or incorrect. As shown in FIG. 4, short answers 402 to one or more questions may be received from a number of remote computing devices, e.g., student computing devices. The short answers 402 may then be automatically grouped into a number of clusters 404A-C and subclusters 406A-H based on features corresponding to the short answers 402 using a specified clustering technique, such as a similarity metric clustering technique or an LDA algorithm clustering technique. Each cluster 406A-C may then be quickly labeled as correct (“+”) or incorrect (“−”) based on feedback from the user/teacher.

In addition, if a simple text answer key 408 is available, as shown in FIG. 4, the answer key 408 may be used to automatically label at least a portion of the short answers 402 as correct or incorrect. Once the clusters 404A-C have been labeled, the user may manually relabel any of the subclusters 406A-H within the clusters 404A-C. Furthermore, the user may manually relabel individual short answers 402 within the subclusters 406A-H.

Exemplary Implementation of Techniques Described Herein for Clustering Short Answers to Questions

The following description provides details of an exemplary implementation of the techniques described herein for clustering short answers to questions. It is to be understood that the techniques described herein are not limited to this exemplary implementation but, rather, may include any number of different techniques for clustering short answers to questions, as described with respect to FIG. 2.

To demonstrate the techniques described herein for clustering short answers to questions, twenty questions may be selected from the United States Citizenship Exam (USCIS, 2012) and offered to two groups. According to the exemplary implementation described herein, 100 short answers from the first group may be used for the training process, and 698 short answers from the second group may be used for the testing process. A first subset of the questions, e.g., questions 1-8, 13, and 20, may be selected for the testing and training processes, since that subset of questions represents a wide range of answer lengths, e.g., from a few words to several sentences. The particular questions that are to be manually graded are listed in Table 1, as well as the average answer length and the number of case-independent unique answers. In addition to splitting the answers between the training process and the testing process, all training of classifiers and parameter settings may be done on a second subset of questions that is the complement of the first subset of questions, e.g., questions 9-12 and 14-19, to prevent any biasing from the target set.

According to the exemplary implementation described herein, two different types of labeling are used for the data. The first type of labeling identifies groups of answers that are semantically equivalent. This type of labeling is used to train the similarity metric between items and is done by a single labeler, e.g., an author, on the second subset of questions. This ensures that general measures are being learned, rather than measures that are specific to particular questions or students.

TABLE 1
Subset of Questions that may be Used for
Evaluating the Data Characteristics for the
698 Short Answers from the Second Group

| Question | | Average | |
|---|---|---|---|
| Number | Unique | Length | Question |
| 1 | 57 | 3.3 | What are the first ten amendments to |
| | | | the U.S. Constitution called? |
| 2 | 132 | 3.2 | What is one right or freedom from |
| | | | the First Amendment? |
| 3 | 586 | 7.8 | What did the Declaration of |
| | | | Independence do? |
| 4 | 205 | 2.0 | What is the economic system in |
| | | | the United States? |
| 5 | 138 | 1.5 | Name one of the three branches |
| | | | of the United States government. |
| 6 | 219 | 2.8 | Who or what makes federal |
| | | | (national) laws in the US? |
| 7 | 395 | 5.2 | Why do some states have more |
| | | | Representatives than other states? |
| 8 | 157 | 4.0 | If both the President and the Vice- |
| | | | President can no longer serve, who |
| | | | becomes President? |
| 13 | 367 | 4.2 | What is one reason the original |
| | | | colonists came to America? |
| 20 | 276 | 4.8 | Why does the flag have 13 stripes? |

TABLE 2
Differences in Teachers' Judgments
and Inter-Annotator Agreement

| | Number Marked | | | |
|---|---|---|---|---|
| | Correct by Each | | | |
| Question | Teacher out of 698 | | | |
| Number | 1 | 2 | 3 | Kappa |
| 1 | 651 | 652 | 651 | 0.992 |
| 2 | 609 | 617 | 613 | 0.946 |
| 3 | 587 | 587 | 492 | 0.574 |
| 4 | 567 | 574 | 541 | 0.864 |
| 5 | 655 | 668 | 658 | 0.831 |
| 6 | 568 | 582 | 548 | 0.838 |
| 7 | 645 | 649 | 652 | 0.854 |
| 8 | 416 | 425 | 409 | 0.966 |
| 13 | 613 | 535 | 557 | 0.659 |
| 20 | 643 | 674 | 678 | 0.449 |

The second type of labeling is the ground truth grading for each student response for each question, which includes labeling each short answer as correct or incorrect. Although an answer key is available according to the exemplary implementation described herein, at least a portion of the short answers are subject to interpretation due to the open-ended nature of short answer questions. For instance, for the question, “Why does the flag have 13 stripes?” the answer key may state, “Because there were 13 original colonies” and “Because the stripes represent the original colonies.” However, if a student answers “13 states,” it may not be clear whether that short answer is to be counted as correct or incorrect. Therefore, different teachers may have different grading patterns, and rather than attempting to optimize for the average labels, the techniques described herein attempt to aid the teacher in quickly converging to the intended grades.

Given the labeled groups of similar short answers (and the remaining answers not assigned to any group), a distance metric, or similarity metric, may be learned between the short answers. This may be accomplished by learning a classifier relating to whether the short answers are similar or not, where each data item may be based on two short answers and a positive or negative label. The resulting classifier may return a score sim(a₁,a₂) between 0 and 1. The distance between the items may be expressed as d(a₁,a₂)=1−sim(a₁,a₂). For each short answer in a labeled group, then, one positive and two negative examples may be generated. The positive example includes the current short answer and one other short answer from the group. The first negative example includes the current short answer and an item from another group, and the second negative example includes an item not placed in any group, for a total of 596 training examples.

For each labeled pair, an array of features expressing the relation between the items may be generated. These features and the labels may then be used to train the classifier. The features may be referred to as “between-item” features, since the features concern the relationships between a₁ and a₂. In addition, all features may be computed after stopwords have been removed from both items. Words that appear in the question as stopwords may also be treated in a process known as “question demoting.” This may result in a noticeable improvement in measuring similarities between student answers and answer key entries. Finally, term frequency (TF) and inverse document frequency (IDF) scores may be computed using the entire corpus of relevant answers, as it does not make use of labeled data.

An online encyclopedia-based latent semantic analysis (LSA) feature may be particularly powerful for grading. In a similar vein, the LSA decomposition may be computed for all English online encyclopedia articles from a particular online encyclopedia using the most frequent 100,000 words as a vocabulary. The similarity between short answers using the top 100 singular vectors may then be computed.

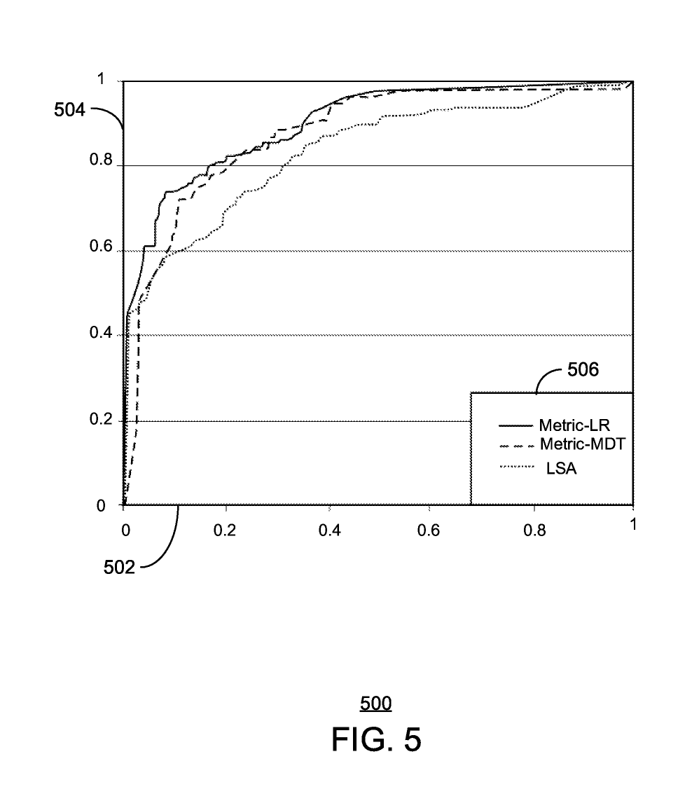

The first feature that is used according to the exemplary implementation described herein is the difference in length, which is the absolute difference between short answer lengths in characters. The second feature is the number of words with matching base forms. For this feature, the derivational base forms for all words may be found, and the words with matching bases may be counted in both answers. The third feature is the maximum IDF of matching base form, which is the maximum IDF of a word corresponding to a matching base. The fourth feature is the term frequency inverse document frequency (TFIDF) similarity of a₁ and a₂. The fifth feature is the TFIDF similarity of letters, which is the letter-based analogue to TFIDF with “stopletters,” e.g., punctuation and spaces, removed. The sixth feature is lowercase string match, which relates to whether the lowercased versions of the strings match, and the seventh feature is the online encyclopedia-based LSA similarity. While these particular features are used according to the exemplary implementation described herein, it is to be understood that any number of additional or alternative features may also be used. With these features and labels, any of a number of classifiers may be trained to model the similarity metric, as discussed further with respect to FIG. 5.

FIG. 5 is a graph 500 showing the performance of the similarity metric described herein. An x-axis 502 of the graph 500 represents the receiver operating characteristic (ROC), and a y-axis 504 of the graph 500 represents different similarity measures on the grouping task. The graph compares ROC curves for several different types of metrics 506, i.e., a logistic regression metric (metric-LR), a mixture of decision trees metric (metric-MDT), and an LSA metric (metric-LSA). The ROC curves may be formed by ten-fold cross-validation in which training was performed on grouping labels for nine of the ten training questions and tested on the tenth. Given that the metrics behave similarly, the logistic regression metric may be used as its output is calibrated, i.e., the output value represents the probability that a₁ and a₂ are in the same group. Furthermore, while the threshold may be tuned for a particular task, the value of 0.5 is meaningful in terms of the probabilistic model and, therefore, is used for judgments of similarity according to the exemplary implementation described herein.

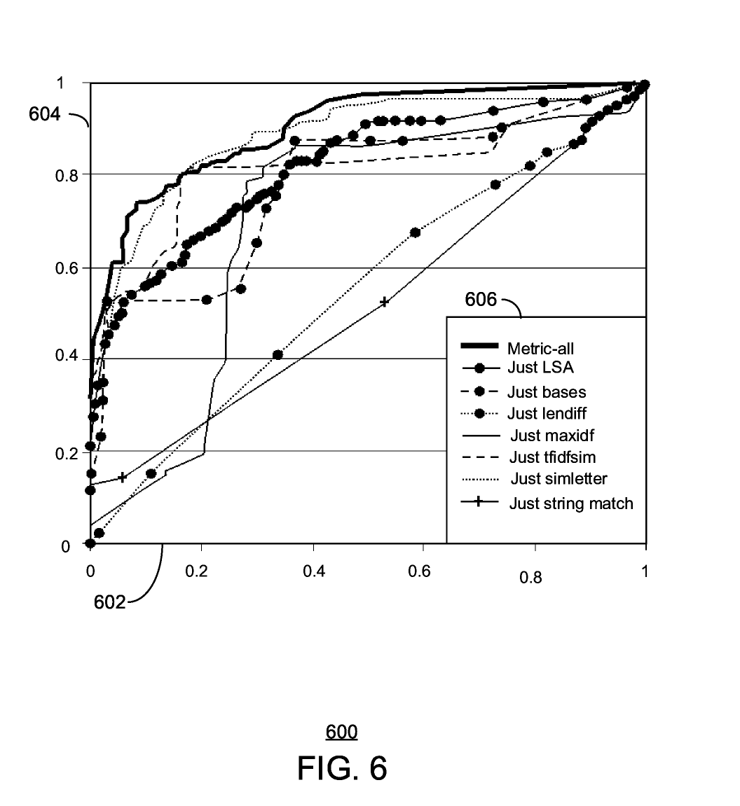

FIG. 6 is a graph 600 showing the performance of the similarity metric described herein when each feature is trained individually. The graph 600 may be used to determine the relative contributions of various features in the classifier. An x-axis 602 of the graph 600 represents the receiver operating characteristic (ROC), and a y-axis 604 of the graph 600 represents different similarity measures. The graph 600 compares ROC curves for several different types of metrics 606. Specifically, the graph 600 compares ROC curves for a metric trained based on all the features (metric-all), as well as metrics trained based on each individual feature (just LSA, just bases, just lendiff, just maxidf, just tfidfim, just simletter, and just string match). As shown in FIG. 6, the TF-IDF similarity feature is a powerful one, as is the letter-based similarity. Overall, though, the classifier trained on all features provides the most robust performance.

To allow the teacher to employ the “divide and conquer” technique, subclusters may be formed within each cluster. Such a two-level hierarchy provides high-level groupings including structured content within each grouping. Clustering and subclustering may allow a teacher to mark a cluster with a label if the majority of items are correct or incorrect, then easily reach in and flip the label of any outlier subclusters within the cluster. Further, while the exemplary implementation described herein uses a setting of ten clusters and five subclusters, any suitable number of clusters and subclusters may be used.

According to embodiments described herein, any of a number of different clustering techniques may be used to group the items into clusters and subclusters. For example, in various embodiments, the items are grouped into clusters and subclusters using the trained similarity metric. Specifically, the k-medoids algorithm with some minor modifications may be used to group the items into clusters and subclusters using the trained similarity metric. In other embodiments, the items are grouped into clusters and subclusters using the LDA algorithm. Furthermore, if an answer key is available, at least a portion of the clusters and subclusters may be marked automatically based on the short answers within the answer key, both for metric clustering and for the LDA algorithm.

As discussed above, metric clustering, e.g., clustering based on the trained similarity metric, may be used to group the items into clusters and subclusters. Specifically, the k-medoids algorithm may be used for metric clustering. First, the trained similarity metric may be used to form a matrix of all pairwise distances between items D, which may be expressed as Dᵢⱼ=1−sim(aᵢ,aⱼ). The canonical procedure for k-medoids, the partitioning around medoids (PAM) algorithm, is then straightforward. A random set of indices may be picked to initialize as centroids. For each iteration, all items may be assigned to the cluster with the centroid that is closest to the item. The centroid for each group may then be recomputed by finding the item in each cluster that is the smallest total distance from the other items. This process may be iterated until the clusters converge.

However, there are a number of subtleties to this clustering technique. First, as items are generally closer to themselves than any other item, often some clusters will “collapse” and end up with the centroid as a single item, while other clusters will become very large. This issue may be mitigated by introducing a redistribution step. According to the redistribution step, if there are any empty or single item clusters, the distribution of distances to the centroids in the other clusters may be examined, and items from larger clusters may be redistributed if the items have become unwieldy. The ratio of the mean to median distance to the centroid may be used as a measure of cluster distortion. When the value of the ratio is greater than one, it is likely that most items have a small distance (resulting in a small median) but there are large-distance items (causing the large mean) that could be moved. In addition, because the classifier is trained to determine the probability of items being in the same group, if the value of the ratio is less than 0.5, the items may not be a good fit for the cluster. Therefore, a final cluster may be reserved for such “misfit” items. This may be implemented via an artificial item with a distance of 0.5 to all other items, which may be used as the centroid of this final cluster. These changes result in the modified PAM algorithm shown in the following code fragment.

| | |
|---|---|
| 1. | Select k − 1 points as centroids c_{1..k-1} |
| 2. | Create “artificial item” N + 1 for last centroid cₖ such that |
| | D_{iN+1} = 0.5 |
| 3. | Until convergence: |

| | |
|---|---|
| a. | Assign each item to closest centroid |
| b. | If there is a cluster Cₛ:\|Cₛ\| ≦ 1 |

| | |
|---|---|
| i. | For each cluster C with centroid c find r_{c} = |
| | mean(D_{jc})/median(D_{jc}) |
| | ∀ j ∈ C |
| ii. | If there is a Cₘ: r_{Cm} > r_{C} > 1 move items |
| | l: D_{lc} > median(D_{jc}) from Cₘ to Cₛ |
| iii. | Recompute centroids for each cluster in |
| | 1..k − 1 as |
| | c_{q} = arg minⱼ Σᵢ Dᵢⱼ ∀j ∈ C |

In various embodiments, the conventional LDA algorithm may be used as the baseline for the clustering process. However, as discussed above, the LDA approach is sensitive to individual words and depends on precisely the same words being used in multiple short answers. According to embodiments described herein, to reduce the effect of this sensitivity, simple stemming may be applied to the words.

While a user-facing system based on the techniques described herein involves an interactive experience leveraging the strengths of both the machine, i.e., the computing system, and the human, i.e., the user of the computing system, it may be desirable to measure how user actions translate into grading progress. In the model of interaction described herein, there are two main actions the user can perform in addition to labeling individual items. Specifically, the user can label all of the items in a cluster as correct or incorrect, or can label all of the items in a subcluster as correct or incorrect. To choose between these two main actions, the user may be modeled as picking the next action that will maximally increase the number of correctly graded items. In intuitive terms, this amounts to the user taking an action when the majority of the items in the cluster or subcluster have the same label and are either unlabeled or labeled incorrectly, and prioritizing clusters where this will have the most benefit (i.e., large clusters). To prevent the undoing of earlier work, clusters are labeled before subclusters contained within each cluster can have their labels “flipped.” When no actions will result in an increase in correct labels, the process is complete, and the remaining items may be labeled individually.

When an answer key is available, embodiments described herein provide mechanisms for both algorithms to automatically perform a subset of the available actions. In the case of the metric clustering technique that is based on the similarity metric, the distance Dᵢⱼ between any user answer and any answer key item may be determined. The “correctness” of an answer may be computed as the maximum similarity to any correct answer key item. If the average correctness for a cluster or subcluster is greater than the classifier's threshold of 0.5, the set is marked as “correct.” Otherwise, the set is marked as “incorrect.” Moreover, the same process may be used to determine the “incorrectness” of an answer. Specifically, the “incorrectness” of an answer may be computed as the maximum similarity to any incorrect answer key item.

In the clustering technique that is based on the LDA algorithm, the model does not allow for computing distances to each item. Instead, all the answer key items may be added as additional items into the clustering. The clusters into which the answer key items are grouped may then be labeled as correct or incorrect depending on whether each model answer within the answer key represents a correct answer or an incorrect answer. While it is possible to label the subclusters instead, labeling the entire cluster typically has the greatest impact on the grading progress in the LDA setting.

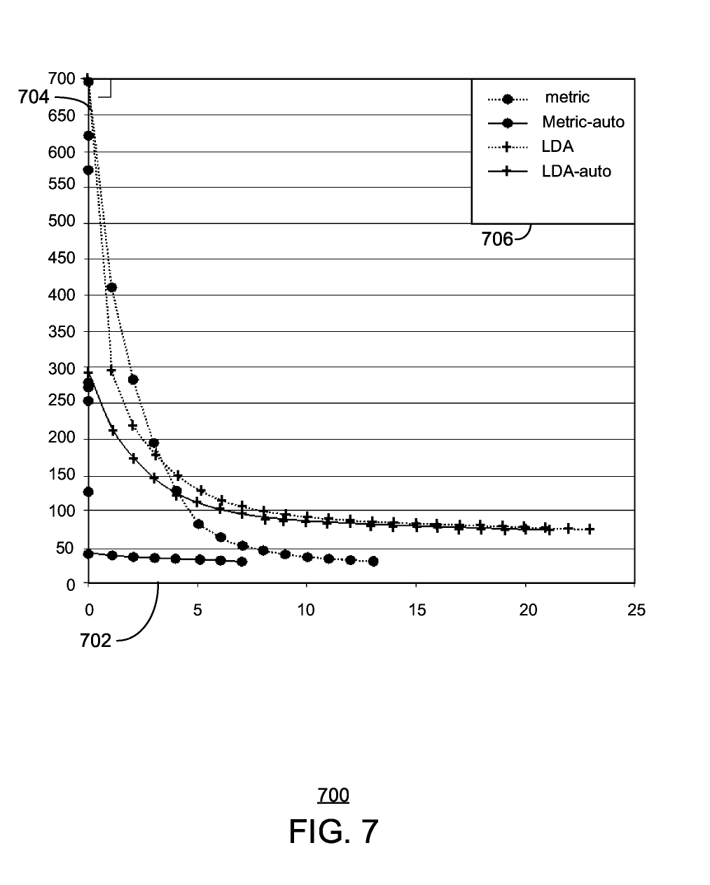

FIG. 7 is a graph 700 showing the number of user actions that are left to correctly grade a particular question according to several different clustering techniques. The graph 700 of FIG. 7 corresponds to grader 1 and question 4 (G1, question 4). An x-axis 702 of the graph 700 represents the number of user actions, and a y-axis 704 of the graph 700 represents the number of short answers left to correctly grade out of the 698 short answers. The graph 700 compares the number of user actions that are left to correctly grade all the short answers corresponding to G1, question 4 according to several different clustering techniques 706, including the metric clustering technique (metric), an automatic metric clustering technique (metric-auto), the LDA algorithm technique (LDA), and the automatic LDA algorithm technique (LDA-auto).

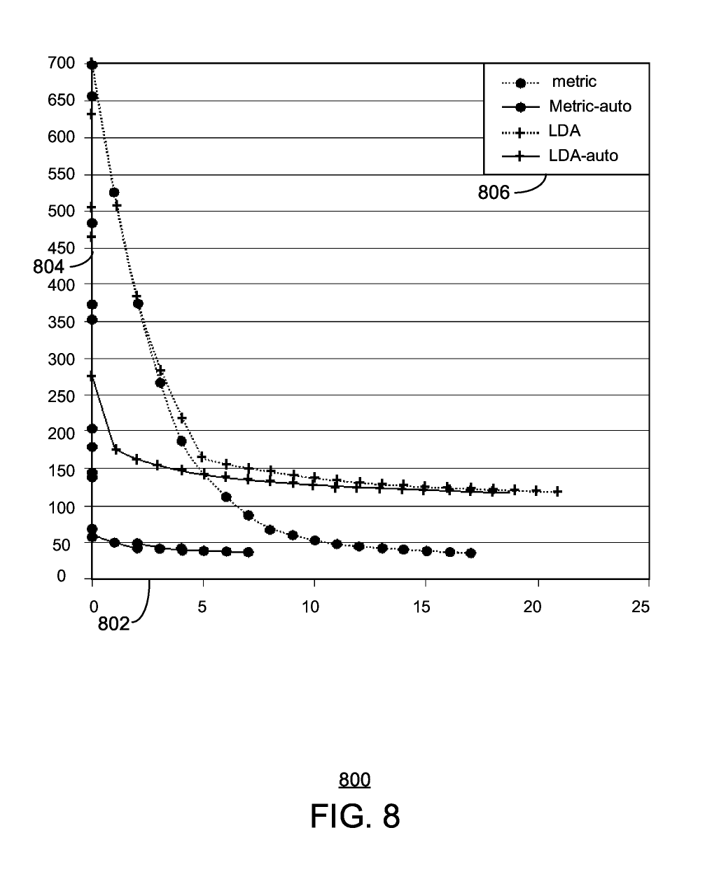

FIG. 8 is a graph 800 showing the number of user actions that are left to correctly grade another question according to several different clustering techniques. The graph 800 of FIG. 8 corresponds to grader 2 and question 13 (G2, question 13). An x-axis 802 of the graph 800 represents the number of user actions, and a y-axis 804 of the graph 800 represents the number of short answers left to correctly grade out of the 698 short answers. The graph 800 compares the number of user actions that are left to correctly grade all the short answers corresponding to G2, question 13 according to several different clustering techniques 806, including the metric clustering technique (metric), the automatic metric clustering technique (metric-auto, i.e., making use of the answer key, as described herein), the LDA algorithm technique (LDA), and the automatic LDA algorithm technique (LDA-auto, i.e., making use of the answer key, as described herein).

As shown in FIGS. 7 and 8, the metric clustering technique allows the short answers to be graded with fewer user actions than the LDA algorithm technique. Furthermore, when automatic actions are added, the short answers may be graded with even fewer user actions.

To examine the overall potential of the techniques described herein with respect to the grading task, it may be desirable to determine an appropriate metric to use, as well as appropriate baselines. As the techniques described herein work in concert with the user, e.g., a human teacher, it may be desirable to maximize the result of a small amount of human effort. Therefore, the results and baselines may be reported in terms of the “number of actions left after N manual actions.” This measure specifies how much the grading task would progress for “grading on a budget.” Specifically, after the algorithm has performed all automatic actions, and the teacher has performed the N best next actions, i.e., those resulting in maximal gain of correctly graded items, the remaining number of actions for completing the grading task may be computed. In this context, each action includes either a cluster or subcluster flip or an individual relabeling of a short answer. The benefit of this measure is that, given a set of short answers and corresponding labels, any clustering technique may be quantitatively compared with respect to the grading task.

In Table 3, the values for each teacher/grader (G1-G3) after three manual actions (N=3) are shown for both clustering techniques, as well as using the individual classifiers, i.e., metric, the LSA value alone, and “always-yes,” i.e., marking all answers as correct. For the majority of the questions, the metric clustering technique described herein involves fewer user actions by a large margin. Specifically, the metric clustering technique described herein involves an average of 53% fewer user actions than the LDA-based method and 39% fewer actions than the metric classifier operating on individual items.

TABLE 3
Number of User Actions Left for Each Question After Automatic
Actions and Three User Actions When an Answer Key Exists, Comparing Various
Grading Techniques for Each Individual Teacher/Grader

| | Metric | | | LDA | | | Metric | | | LSA | | | “Yes” | | |
|---|---|---|---|---|---|---|---|---|---|---|---|---|---|---|---|
| Question | Clustering | | | Clustering | | | Individual | | | Individual | | | Individual | | |
| Number | G1 | G2 | G3 | G1 | G2 | G3 | G1 | G2 | G3 | G1 | G2 | G3 | G1 | G2 | G3 |
| 1 | 1 | 0 | 1 | 11 | 12 | 11 | 2 | 1 | 2 | 11 | 10 | 11 | 45 | 43 | 44 |
| 2 | 12 | 10 | 12 | 42 | 34 | 38 | 22 | 20 | 22 | 38 | 38 | 38 | 86 | 78 | 82 |
| 3 | 92 | 94 | 163 | 110 | 110 | 184 | 98 | 106 | 141 | 247 | 249 | 242 | 108 | 108 | 203 |
| 4 | 35 | 27 | 53 | 92 | 80 | 106 | 52 | 59 | 46 | 67 | 62 | 53 | 128 | 121 | 154 |
| 5 | 17 | 20 | 22 | 21 | 19 | 23 | 42 | 33 | 45 | 24 | 19 | 19 | 40 | 27 | 37 |
| 6 | 30 | 30 | 54 | 65 | 58 | 71 | 113 | 125 | 143 | 130 | 136 | 146 | 127 | 113 | 147 |
| 7 | 31 | 27 | 24 | 54 | 50 | 47 | 83 | 79 | 78 | 515 | 517 | 518 | 50 | 46 | 43 |
| 8 | 14 | 15 | 14 | 207 | 212 | 204 | 14 | 11 | 21 | 9 | 12 | 16 | 279 | 270 | 286 |
| 13 | 74 | 41 | 45 | 82 | 133 | 121 | 101 | 61 | 55 | 126 | 64 | 76 | 82 | 160 | 138 |
| 20 | 19 | 12 | 10 | 47 | 26 | 22 | 38 | 19 | 11 | 35 | 84 | 70 | 52 | 21 | 17 |

Furthermore, Table 4 shows the number of user actions that are left for both clustering techniques when an answer key is not available. While the numbers are obviously greater than those in Table 3, the numbers are still small compared to the full work of grading 698 answers.

TABLE 4
Number of User Actions Left for Both Clustering Techniques
After Three User Actions When No Answer Key is Available

| | Metric | | | LDA | | |
|---|---|---|---|---|---|---|
| Question | Clustering | | | Clustering | | |
| Number | G1 | G2 | G3 | G1 | G2 | G3 |
| 1 | 7 | 7 | 7 | 12 | 13 | 12 |
| 2 | 18 | 16 | 18 | 44 | 36 | 40 |
| 3 | 99 | 100 | 167 | 114 | 114 | 188 |
| 4 | 41 | 33 | 65 | 94 | 82 | 108 |
| 5 | 22 | 28 | 26 | 24 | 24 | 26 |
| 6 | 35 | 32 | 54 | 68 | 61 | 74 |
| 7 | 38 | 33 | 31 | 58 | 54 | 51 |
| 8 | 23 | 23 | 21 | 208 | 213 | 205 |
| 13 | 80 | 51 | 55 | 86 | 135 | 124 |
| 20 | 27 | 20 | 20 | 49 | 28 | 24 |

In various embodiments, grouping items into clusters and subclusters allows a teacher to detect modes of misunderstanding in her students. The teacher may then provide the students with rich feedback in the form of comments on the cluster or subcluster. For example, the teacher may detect a mode of misunderstanding within a cluster or subcluster, and may send a single message to all the students whose short answers fell into that cluster or subcluster to explain the nature of the students' confusion. In addition, the teacher may revise her teaching materials based on such modes of misunderstanding.

Furthermore, embodiments described herein may allow the user/teacher to provide interactive feedback that will improve the clustering technique and the grading task in general. For example, the user may manually move short answers between clusters and subclusters, thus providing relevance feedback. The clustering technique may then be updated based on the feedback provided by the user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for clustering short answers to questions, comprising:
receiving, at a computing device, a plurality of short answers to a question from a plurality of remote computing devices; and
automatically grouping the plurality of short answers into a plurality of clusters based on features corresponding to the plurality of short answers using a specified clustering technique.

2. The method of claim 1, comprising labeling any of the plurality of clusters with a label, score, or comment.

3. The method of claim 2, comprising:
receiving feedback from a user of the computing device; and
labeling any of the plurality of clusters with the label, score, or comment based on the feedback from the user.

4. The method of claim 2, comprising:
analyzing a short answer key comprising model short answers to the question, wherein each model short answer comprises a correct answer or an incorrect answer to the question as well as an optional comment about the answer;
determining a similarity between the model short answers and the short answers within each of the plurality of clusters; and
labeling each of the plurality of clusters with the label, score, and optional comment based on the similarity between the model short answers and the short answers within each of the plurality of clusters.

5. The method of claim 2, comprising displaying a report to a user of the computing device, wherein the report comprises the labels, scores, and comments of the plurality of clusters and a distribution of the plurality of short answers based on the plurality of clusters.

6. The method of claim 2, comprising:
receiving feedback from the user of the computing device, wherein the feedback corresponds to a particular cluster; and
sending the feedback to the remote computing devices from which the short answers within the particular cluster were received.

7. The method of claim 2, comprising using the plurality of clusters that are labeled or individual short answers within the plurality of clusters that are labeled to determine labels, scores, or comments for unlabeled clusters or individual, unlabeled short answers.

8. The method of claim 1, comprising automatically grouping the short answers within each of the plurality of clusters into a plurality of subclusters based on the similarities between the plurality of short answers using a second specified clustering technique.

9. The method of claim 1, comprising:
receiving, at the computing device, a plurality of sets of short answers for an assessment from the plurality of remote computing devices, wherein each set of short answers comprises a short answer to each of a plurality of questions within the assessment;
automatically grouping the short answers to each of the plurality of questions within the assessment into a plurality of clusters based on features corresponding to the short answers using the specified clustering technique;
labeling each of the plurality of clusters with a label, score, or comment based on feedback from a user of the computing device or model short answers to the plurality of questions obtained from an answer key, or both; and
calculating a grade for the assessment corresponding to each set of short answers based on the label or the score of the cluster in which each short answer within a particular set of short answers is located.

10. The method of claim 1, wherein using the specified clustering technique comprises using a trained similarity metric.

11. A computing system for clustering short answers to questions, comprising:
a processor that is configured to execute stored instructions;
a network that is configured to communicably couple the computing system to a plurality of remote computing systems;
an interface that is configured to allow a user of the computing system to provide feedback; and
a system memory, wherein the system memory comprises code configured to:
receive a set of short answers for an assessment from each of the plurality of remote computing systems, wherein each set of short answers comprises a short answer to each of a plurality of questions within the assessment;
automatically group the short answers to each of the plurality of questions within the assessment into a plurality of clusters based on features corresponding to the short answers using a specified clustering technique; and
label each of the plurality of clusters corresponding to each of the plurality of questions with a label, score, or comment based on the feedback from the user or model short answers to the plurality of questions obtained from an answer key, or both.

12. The system of claim 11, wherein the system memory comprises code configured to calculate a grade for the assessment corresponding to each set of short answers based on the label or the score of the cluster in which each short answer within a particular set of short answers is located.

13. The computing system of claim 11, wherein the system memory comprises code configured to:
determine a similarity between a model short answer to one of the plurality of questions obtained from the answer key and each short answer within each of the plurality of clusters corresponding to the one of the plurality of questions; and
label each of the plurality of clusters with a label or a score based on the similarity between the model short answer and the short answers within each of the plurality of clusters.

14. The computing system of claim 11, wherein the system memory comprises code configured to use the plurality of clusters that are labeled or individual short answers within the plurality of clusters that are labeled to determine label, scores, or comments for unlabeled clusters or individual, unlabeled short answers.

15. The computing system of claim 11, comprising a display device that is configured to display a report to the user, wherein the report comprises the labels, scores, and comments on the plurality of clusters and a distribution of the short answers based on the plurality of clusters.

16. The computing system of claim 15, wherein the system memory comprises code configured to:
allow the user to provide feedback corresponding to a particular cluster in response to the report via the interface; and
send the feedback to the remote computing systems from which the short answers within the particular cluster were received via the network.

17. One or more computer-readable storage media for storing computer-readable instructions, the computer-readable instructions providing a system for clustering short answers to questions when executed by one or more processing devices, the computer-readable instructions comprising code configured to:
receive a plurality of short answers to a question from a plurality of remote computing devices; and
automatically group the plurality of short answers into a plurality of clusters based on features corresponding to the plurality of short answers using a specified clustering technique.

18. The one or more computer-readable storage media of claim 17, wherein the computer-readable instructions comprise code configured to label any of the plurality of clusters with a label, score, or comment based on user feedback or model short answers to the question obtained from an answer key, or both.

19. The one or more computer-readable storage media of claim 18, wherein the computer-readable instructions comprise code configured to:
automatically group the short answers within each of the plurality of clusters into a plurality of subclusters based on the features corresponding to the plurality of short answers using a second specified clustering technique; and
relabel any of the plurality of subclusters with a new label, score, or comment based on user feedback or the model short answers to the question obtained from the answer key, or both.

20. The one or more computer-readable storage media of claim 17, wherein the computer-readable instructions comprise code configured to:
display a report to a user, wherein the report comprises labels, scores, or comments on the plurality of clusters and a distribution of the plurality of short answers based on the plurality of clusters;
allow the user to provide feedback corresponding to a particular cluster in response to the report; and
send the feedback to the remote computing devices from which the short answers within the particular cluster were received.
